(19) United States
(12) Patent Application Publication
(10) Pub. No.: US 2019/0191790 A1
(43) Pub. Date: Jun. 27, 2019

(54) LIQUID STRETCH COATING FOR GARMENTS AND METHODS FOR APPLICATION THEREOF

(71) Applicant: VF Jeanswear LP, Greensboro, NC (US)

(72) Inventors: Dhruv Agarwal, Greensboro, NC (US); Achille Bivigou, Greensboro, NC (US); Meghan Surra, Greensboro, NC (US); Akash Pardeshi, Greensboro, NC (US)

(21) Appl. No.: 16/228,076

(22) Filed: Dec. 20, 2018

Related U.S. Application Data
(60) Provisional application No. 62/608,918, filed on Dec. 21, 2017.
(60) Provisional application No. 62/692,980, filed on Jul. 2, 2018.

(51) Int. Cl. A41D 1/06; A41D 27/00; A41D 31/00; A41B 1/08; D06M 15/263; C09D 133/04

(52) U.S. Cl. CPC A41D 1/06; A41D 27/00; A41D 31/00; A41B 1/08; D06M 2101/06; C09D 133/04; A41D 2400/26; A41D 2400/36; D06M 15/263

(57) ABSTRACT

A garment includes yarns including an elastic component and a coating including an acrylic polymer or copolymer thereof. The coating is located on at least one discrete region of the garment. A method for applying a coating to at least one discrete region of a garment with a spray apparatus includes placing the garment on a conveyance system, advancing the garment proximate to at least one spray nozzle, and operating the controller to activate the at least one spray nozzle and apply the coating to the at least one discrete region of the garment.

### RELATED APPLICATIONS

This application claims the benefit of U.S. Provisional Application No. 62/608,918 filed Dec. 21, 2017 and U.S. Provisional Application No. 62/692,980 filed Jul. 2, 2018, the disclosures of which are incorporated herein by this reference in their entireties.

### FIELD OF THE DISCLOSURE

The present disclosure relates to coatings for garments, and in particular for coatings for stretch garments and methods for application thereof that provide structure retention to discrete regions of the garment following stretching.

### BACKGROUND OF THE DISCLOSURE

The global market for comfort denim has an increased demand for denim with excellent resilience, good stretchability and long-lasting structure retention. Stretch denim provides many of these properties—in addition to excellent fit and good elastic recovery—and as a result, the stretch denim market continues to grow.

Comfort is a particular attribute that consumers desire in denim jeans. Denim jeans with high comfort and flexibility are produced by blending spandex with other yarns, including but not limited to polyester and cotton yarns. Though spandex denims provide excellent comfort and mobility to consumers, they have limitations, including sagging and bagging at the knees and rear caused by regular wear and tear. This can be particularly distressing for certain consumers who expect stretch denims to perform exceptionally better than regular denims. These consumers expect stretch denims to have excellent comfort and retain a high degree of dimensional stability and durability. In other words, denim consumers expect stretch denims to fit well without constriction throughout the day and weeks so that the wearers still have the freedom to move around freely. In addition, they expect their stretch denims to deliver reduced sagging and bagging even after multiple uses. This is not the case, however.

Polyurethane coatings have been applied to denim jeans, such as described in U.S. Pat. No. 8,984,668 to Tulin et al., but such jeans do not provide satisfactory structure retention, i.e., they do not sufficiently return to their original shape after being stretched.

These and other shortcomings are addressed by aspects of the present disclosure.

### SUMMARY

Aspects of the disclosure relate to a garment including yarns including an elastic component and a coating including an acrylic polymer or copolymer thereof. The coating is located on at least one discrete region of the garment.

Aspects of the disclosure further relate to method for applying a coating to at least one discrete region of a garment with a spray apparatus. The method includes placing the garment on a conveyance system, advancing the garment proximate to at least one spray nozzle, and operating the controller to activate the at least one spray nozzle and apply the coating to the at least one discrete region of the garment.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A and 1B illustrate discrete regions of a garment onto which a coating according to aspects of the disclosure may be applied.

FIG. 2 illustrates a prior art method for applying a coating to a garment.

FIG. 3 illustrates a method for applying a coating to a garment according to aspects of the disclosure.

FIG. 4 illustrates a spray nozzle according to aspects of the disclosure.

FIG. 5 illustrates a spray tip according to aspects of the disclosure.

FIG. 6 illustrates a discrete region of a garment onto which a coating according to aspects of the disclosure may be applied.

FIG. 7 is a block diagram illustrating a method for applying a coating to a garment according to aspects of the disclosure.

FIG. 8 is a chart comparing structure retention of fabrics coated according to aspects of the disclosure to those of conventionally coated fabrics.

FIG. 9 is another chart comparing structure retention of fabrics coated according to aspects of the disclosure to those of conventionally coated fabrics.

FIG. 10 is a graph showing performance enhancement of coated fabrics according to aspects of the disclosure.

FIG. 11 is a photograph comparing dyed fabrics according to aspects of the disclosure.

### DETAILED DESCRIPTION

The present disclosure can be understood more readily by reference to the following detailed description of the disclosure and the Examples included therein. In various aspects, the present disclosure pertains to a garment including yarns including an elastic component and a coating including an acrylic polymer or copolymer thereof. The coating is located on at least one discrete region of the garment. Methods for applying a coating to at least one discrete region of a garment with a spray apparatus are also described. The coating provides stretch garments with improved structure retention properties as compared to garments that do not include the coating or that include other conventional (e.g., polyurethane) coatings.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an acrylic polymer” includes mixtures of two or more acrylic polymers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Acrylic Coated Stretch Garments

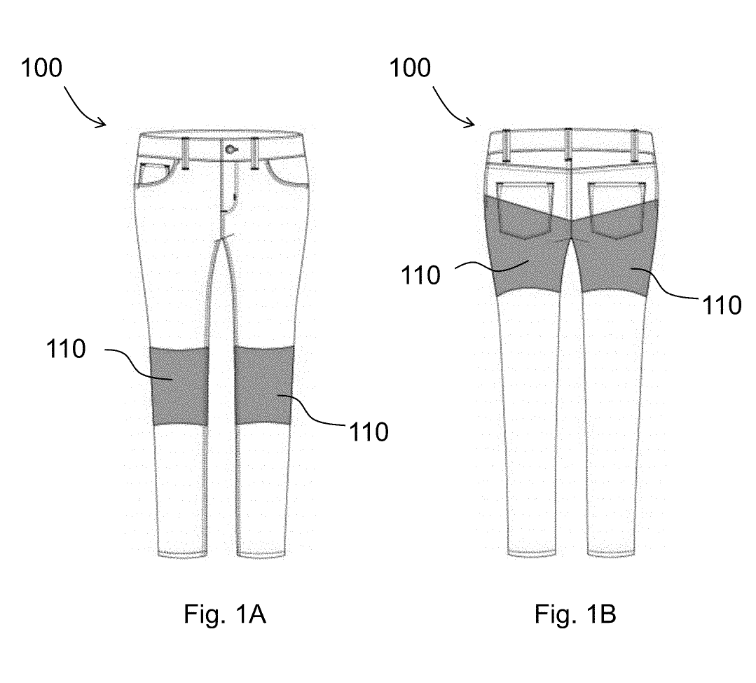

Aspects of the disclosure relate to coatings for stretch garments that provide structure retention to discrete regions of the garment. In particular aspects, and with reference to FIG. 1, the garment 100 includes yarns including an elastic component, such as but not limited to spandex (e.g., Lycra®) or elastane.

A coating is included on at least one discrete region 110 of the garment 100. The coating includes an acrylic polymer or copolymer thereof. As used herein, an acrylic polymer is a polymer derived from acrylic acid or acrylates.

In some aspects the coating further includes a crosslinker component. The crosslinker component may enhance bonding of the acrylic polymer/copolymer to the fabric of the garment. Exemplary crosslinker components that may be suitable in aspects of the disclosure include, but are not limited to, polycarbodiimide, maleic anhydride, copolymers thereof, derivatives, thereof and combinations thereof. When the crosslinker component is included, the coating may include from about 1 wt % to about 99 wt % of the acrylic polymer and from about 1 wt % to about 99 wt % of the crosslinker component.

In some aspects the coating further includes from greater than 0 wt % to about 5 wt % of an additional additive. The additional additive may include, but is not limited to, a dye, a pigment, an ultraviolet resistant additive, an antimicrobial additive, an odor control additive, a moisture transport additive, a flame retardant, an insect repellant, a fragrance, or a combination thereof.

The coating may be diluted prior to applying it onto the discrete region(s) 110 of the garment 100 provided that desired performance of the discrete region 110 (e.g., structure retention) is maintained. In some aspects the coating is diluted so that the coating includes from about 5 wt % to about 90 wt % of the concentrated mixture (acrylic polymer or copolymer, crosslinker component and additional additive(s) if included) and about 10 wt % to about 95 wt % of the diluent. In one aspect the diluent is water. Other suitable diluents may be used.

As noted herein, the garment 100 includes yarns including an elastic component. The yarns further include in some aspects natural fibers, synthetic fibers or a combination thereof. The natural fibers may include, but are not limited to cotton, wool, silk, hemp, flax, jute, Kapok and combinations thereof. The synthetic fibers may include, but are not limited to viscose, polyester, nylon, polypropylene, modacrylic, aramid, thermoplastic urethane (TPU), polybenzimidazole (PBI), polybenzoxazole (PBO), melamine and combinations thereof. The fibers may be in any form, including but not limited to spun yarns, filament yarns, stretch broken yarns, core spun yarns, or any combination thereof.

In some aspects, such as that illustrated in FIGS. 1A and 1B, the garment 100 is pants and the at least one discrete region of the garment is a hip region, a thigh region, a knee region or a combination thereof. In further aspects the garment 100 is a shirt and the at least one discrete region 110 is a collar region, a sleeve region, a cuff region or a combination thereof.

The coating including an acrylic polymer or copolymer thereof provides improved structure retention to the garment as compared to a garment that does not include the coating or that includes other known coatings (such as polyurethane coatings). Specifically, for garments that include stretch fabrics (e.g., stretch denim), the coating enhances the ability of the fabric to return to its original shape after being stretched. Thus, in certain aspects the at least one discrete region 110 of the garment 100 that includes the coating according to the present disclosure has a structure retention that is at least 5% improved as compared to a discrete region of a garment including a substantially similar coating including a polyurethane polymer. In further aspects, the at least one discrete region 110 of the garment 100 including the coating has a structure retention that is at least 10% improved, or at least 12% improved, or at least 15% improved, or from about 5% to about 50% improved, or from about 5% to about 20% improved, or from about 8% to about 20% improved, or from about 10% to about 20% improved, as compared to a discrete region of a garment including a substantially similar coating including a polyurethane polymer. Structure retention is quantified by a percent hysteresis determination as described below in the Examples.

In some aspects the coating may be applied onto the at least one discrete region 110 of the garment 100 at a level of from about 20 grams per square meter (g/m²) to about 150 g/m², as measured by the weight of dry coating on the fabric. In certain aspects a discrete region 110 having a coating applied at this level (about 20 g/m² to about 150 g/m²) has a structure retention of less than 60% hysteresis after 5 home launderings.

The coating may be applied onto the at least one discrete region 110 of the garment 100 by any suitable method. In some aspects the coating is applied onto the at least one discrete region 110 of the garment 100 using a spray apparatus such as that described herein. In further aspects the coating is applied onto the at least one discrete region 110 of the garment 100 by a manual spray method, or a conventional automated spray method.

### Methods for Applying Coatings

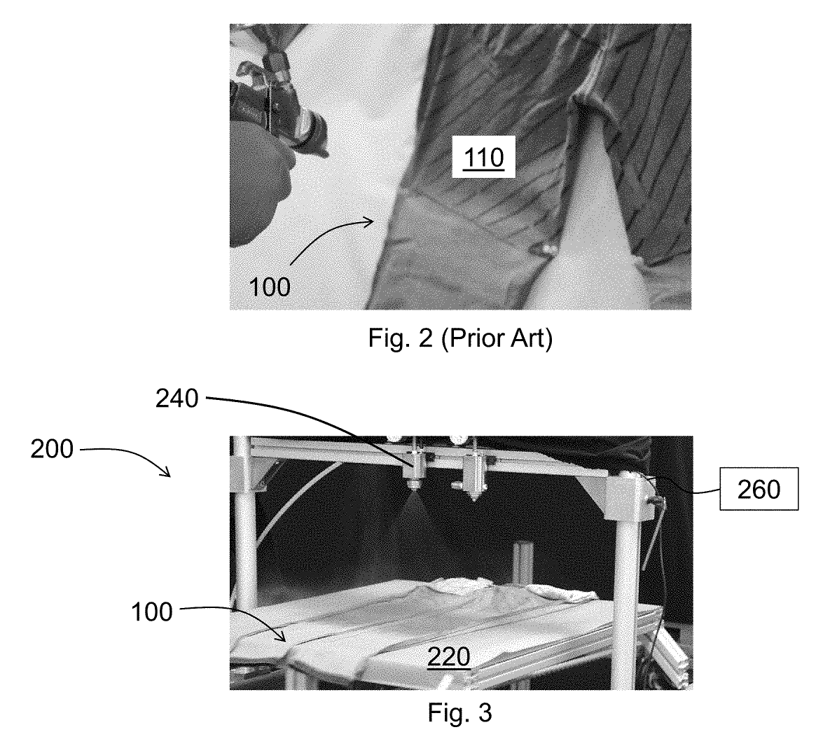

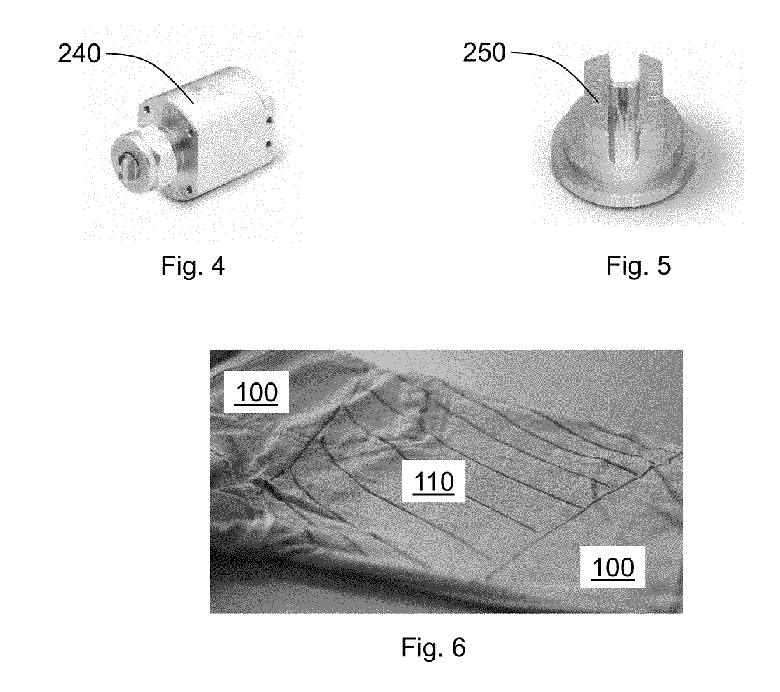

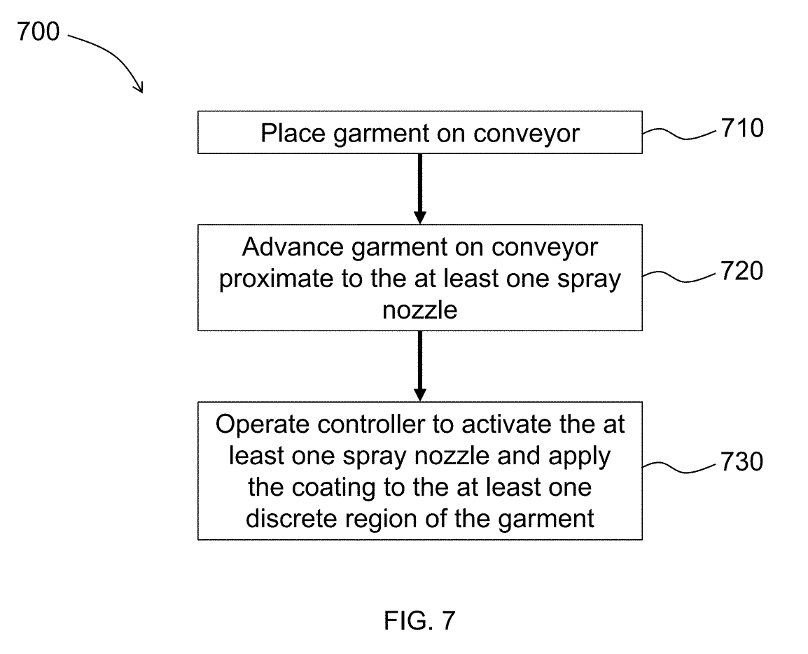

Conventional methods for applying coatings to stretch fabrics include manual application methods, such as those illustrated in FIG. 2. In contrast, and with reference to FIGS. 2-7, aspects of the present disclosure relate to a method 700 for applying a coating to at least one discrete region of a garment with a spray apparatus 200. The apparatus includes a conveyance system 220, at least one spray nozzle 240 and a controller 260. At step 710 of the method, the garment 100 is placed on the conveyance system 220. At step 720 the garment 100 is advanced on the conveyance system 220 so that it is proximate (e.g., below) the at least one spray nozzle 240. At step 730 the controller 260 is operated to activate the at least one spray nozzle 240 and apply the coating to at least one discrete region 110 of the garment 100.

In some aspects the at least one spray nozzle 240 is a hydraulic electrically actuated spray nozzle. One purely exemplary spray nozzle suitable for use in aspects of the disclosure is the AutoJet® Precision Spray Control Systems AA10000AUH-10 PulsaJet® spray nozzle. This spray nozzle, typically used in food contact applications, has the ability to perform Pulse Width Modulation (PWM). PWM is a control principle that provides for a significant reduction in flow by regulating the on/off time in which the valve operates. Pulses of on-time and off-time produce a spray pattern that appears continuous but in fact results in a reduction in overall flow delivered to the target surface. When used in combination with the AutoJet® 2008 PWM spray control panel (which is a purely exemplary controller 260 suitable for use in the present disclosure), high speed cycling up to 15,000 cycles per minute can be achieved. In some aspects the controller 260 is a 24 volt direct current (24 VDC) controller.

In some aspects the at least one spray nozzle 240 includes a nozzle tip 250, as shown in FIG. 5. The nozzle tip can provide a customized spray pattern of the coating onto the at least one discrete region 110 of the garment 100. In a purely exemplary aspect the nozzle tip is a UniJet® E-series TPU-style hydraulic spray nozzle tip, which integrates with the PulsaJet® spray nozzle described above. This nozzle tip produces an even flat fan spray pattern with a uniform distribution of small to medium sized drops. The TPU-style nozzle tip features a recessed orifice for protection against damage. Interchangeable nozzle tips are available in a variety of body type/sizes, spray angles and capacities. Other nozzle tips suitable for use in aspects of the disclosure include, but are not limited to, TPU-6502E-SS, TPU-6505E-SS, TPU-8008E-SS, and TPU-8015E-SS nozzle tips.

The spray apparatus 200 may also include a conveyance system 220 as shown in FIG. 3. The conveyance system 220 allows the at least one spray nozzle 240 to be mounted to a stationary cross-bar support above the conveyance system 220. The speeds and on/off functions of the conveyance system may be controlled by the controller 260. The acrylic coating solution may be delivered through the at least one spray nozzle 240 from a pressurized vessel (not shown). The controller 260 may also controller spray cycles and duty cycles for the at least one spray nozzle 240. Any suitable conveyance system 220 that can move the garment 100 through the spray apparatus 200 may be used. The conveyance system may include, but is not limited to, a belt, a plurality of hangers, a plurality of mannequins, a plurality of rollers or a combination thereof. The at least one spray nozzle 240 need not be stationary, and in some aspects could move relative to the garment 100 to apply the coating to at least one discrete region 110 of the garment 100.

The coating may be applied at any viscosity that provides sufficient flow of coating solution and dispersion onto the at least one discrete region of the garment. In some aspects the coating is applied at a viscosity of about 3 centipoise (cP) to about 50 cP. The coating may in some aspects include about 1% to about 60% solids, or in particular aspects about 40% solids, or about 50% solids, or about 55% solids, or up to about 50% solids, or up to about 55% solids, or up to about 60% solids. The solids include the acrylic polymer or copolymer thereof.

The coating may be applied any number of times as desired until the desired coating level is achieved. The garment may be dried after each application of coating, after a certain number of applications, or after all applications are completed. In some aspects the garment is placed in an oven and dried. In particular aspects the garment is dried at a temperature of from about 70 degrees Celsius (° C.) to about 150° C. at a time of from about 2 minutes to about 20 minutes. In further aspects the garment is dried at a temperature of about 85° C. to about 120° C. at a time of from about 3 minutes to 15 minutes. Drying temperatures and times can be varied depending on the amount of coating applied, the composition of the coating and the substrate (e.g., garment material, weight, form, etc.).

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A garment comprising yarns comprising an elastic component, the garment comprising a coating comprising an acrylic polymer or copolymer thereof, the coating located on at least one discrete region of the garment.

Aspect 2. The garment according to Aspect 2, wherein the coating further comprises a crosslinker component, and wherein the coating comprises from about 1 wt % to about 99 wt % of the acrylic polymer and from about 1 wt % to about 99 wt % of the crosslinker component.

Aspect 3. The garment according to Aspect 1 or 2, wherein the coating further comprises from greater than 0 wt % to about 5 wt % of an additional additive.

Aspect 4. The garment according to Aspect 3, wherein the additional additive comprises a dye, a pigment, an ultraviolet resistant additive, an antimicrobial additive, an odor control additive, a moisture transport additive, a flame retardant, an insect repellant, a fragrance, or a combination thereof.

Aspect 5. The garment according to any of Aspects 1 to 4, wherein the yarns further comprise natural fibers, synthetic fibers or a combination thereof.

Aspect 6. The garment according to Aspect 5, wherein the natural fibers comprise cotton, wool, silk, hemp, flax, jute, Kapok and combinations thereof.

Aspect 7. The garment according to Aspect 5, wherein the synthetic fibers comprise viscose, polyester, nylon, polypropylene, modacrylic, aramid, thermoplastic urethane (TPU), polybenzimidazole (PBI), polybenzoxazole (PBO), melamine and combinations thereof.

Aspect 8. The garment according to any of Aspects 1 to 7, wherein the garment is pants and the at least one discrete region of the garment is a hip region, a thigh region, a knee region or a combination thereof.

Aspect 9. The garment according to any of Aspects 1 to 7, wherein the garment is a shirt and the at least one discrete region is a collar region, a sleeve region, a cuff region or a combination thereof.

Aspect 10. The garment according to any of Aspects 1 to 9, wherein the at least one discrete region of the garment has a structure retention that is at least 5% improved as compared to a discrete region of a garment comprising a substantially similar coating comprising a polyurethane polymer instead of the acrylic polymer or copolymer thereof.

Aspect 11. The garment according to any of Aspects 1 to 10, wherein the coating is applied onto the at least one discrete region of the garment at a level of from 20 grams per square meter (g/m²) to 150 g/m² and the at least one discrete region has a structure retention of less than 60% hysteresis after 5 launderings.

Aspect 12. A method for applying a coating to at least one discrete region of a garment with a spray apparatus, the apparatus comprising a conveyance system, at least one spray nozzle and a controller, the method comprising:
a. placing the garment on a conveyance system;
b. advancing the garment proximate to the at least one spray nozzle;
c. operating the controller to activate the at least one spray nozzle and apply the coating to the at least one discrete region of the garment.

Aspect 13. The method according to Aspect 12, wherein the at least one spray nozzle applies the coating to the at least one discrete region of the garment with pulse width modulation.

Aspect 14. The method according to Aspect 13, wherein the pulse width modulation comprises a cycle time of up to 15,000 cycles per minute.

Aspect 15. The method according to any of Aspects 11 to 14, wherein the controller is a 24 volt direct current (24 VDC) controller.

Aspect 16. The method according to any of Aspects 11 to 15, wherein the at least one spray nozzle applies the coating to the at least one discrete region in an even flat fan spray pattern.

Aspect 17. The method according to any of Aspects 11 to 16, wherein the coating is applied at a viscosity of about 3 centipoise (cP) to about 50 cP.

Aspect 18. The method according to any of Aspects 11 to 17, wherein the coating comprises from about 1% to about 60% solids, or in particular aspects about 40% solids, or about 50% solids, or up to about 50% solids, or up to about 60% solids.

Aspect 19. The method according to any of Aspects 11 to 18, wherein the garment is pants and the at least one discrete region of the garment onto which the coating is applied is a hip region, a thigh region, a knee region or a combination thereof.

Aspect 20. The method according to any of Aspects 11 to 18, wherein the garment is a shirt and the at least one discrete region of the garment onto which the coating is applied is a collar region, a sleeve region, a cuff region or a combination thereof.

Aspect 21. The method according to any of Aspects 11 to 20, wherein the coating comprises an acrylic polymer or copolymer thereof.

Aspect 22. The method according to Aspect 21, wherein the coating further comprises a crosslinker component, and wherein the coating comprises from about 1 wt % to about 99 wt % of the acrylic polymer and from about 1 wt % to about 99 wt % of the crosslinker component.

Aspect 23. The method according to Aspect 21 or 22, wherein the coating further comprises from greater than 0 wt % to about 5 wt % of an additional additive.

Aspect 24. The method according to Aspect 23, wherein the additional additive comprises a dye, a pigment, an ultraviolet resistant additive, an antimicrobial additive, an odor control additive, a moisture transport additive, a flame retardant, an insect repellant, a fragrance, or a combination thereof.

Aspect 25. The method according to any of Aspects 11 to 24, wherein the garment comprises yarns comprising an elastic component.

Aspect 26. The method according to Aspect 25, wherein the yarns further comprise natural fibers, synthetic fibers or a combination thereof.

Aspect 27. The method according to Aspect 26, wherein the natural fibers comprise cotton, wool, silk, hemp, flax, jute, Kapok and combinations thereof.

Aspect 28. The method according to Aspect 26, wherein the synthetic fibers comprise viscose, polyester, nylon, polypropylene, modacrylic, aramid, thermoplastic urethane (TPU), polybenzimidazole (PBI), polybenzoxazole (PBO), melamine and combinations thereof.

Aspect 29. The method according to any of Aspects 11 to 28, wherein the conveyance system comprises a belt, a plurality of hangers, a plurality of mannequins, a plurality of rollers or a combination thereof.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1

### Ex1, Inventive Acrylic Composition

An example acrylic composition (Example 1) was made and applied onto discrete regions of denim fabrics according to the following process. An aqueous acrylic dispersion with 51 wt % solids was prepared by Akron Paint and Varnish in Ohio by mixing 95.5 wt % P-0235 Part A with 4.5 wt % of a crosslinker component (Part B) for 15-30 minutes. The aqueous acrylic dispersion was applied onto stretch denim fabrics and onto the high wear zones of the jeans, including areas in the hips, thighs, and knees, to create zones of variable stretch and variable compression.

The viscosity of the aqueous acrylic dispersion was 42 centipoise, and was applied at ambient lab conditions. The stretch denim products were placed in an oven at 90 degrees Celsius (° C.) for either 3 or 7 minutes depending on the substrates. This process was repeated with multiple passes as needed until a suitable add-on was achieved. Three levels of coating, Levels 1-3, as a measure of dry weight of coating on fabric, were applied to the fabrics: Level 1: 20 grams per square meter (g/m²) to 50 g/m²; Level 2: 50 g/m² to 80 g/m²; and Level 3: 80 g/m² to 120 g/m². The stretch denim products were then consecutively washed and dried before they were measured.

### Example 2

### Ex2, Comparative Polyurethane Composition

An aqueous polyurethane dispersion with 41.3 wt % solids and a 7.2 pH was prepared and provided by COVESTRO in Pennsylvania. The polyurethane dispersion was applied onto stretch denim fabrics and onto high wear zones of the jeans, including areas in the hips, thighs, and knees, to create zones of variable stretch and variable compression. The aqueous polyurethane dispersion had a viscosity of 37 cP and was applied at ambient lab conditions. The coated denims were dried in an oven at 90° C. for 10 minutes. This process was repeated, with multiple passes if needed, until appropriate coating levels (Levels 1-3 above) were achieved. The dried denim products were consecutively washed and dried before they were measured.

### Test Methods

Structure retention and elastic properties of the coated stretch denims were measured in accordance with the general method of ASTM D5035 Standard Test Method for Breaking Force and Elongation of Textile Fabrics. Stretch denim specimens having a 3-inch (in.) gauge length were elongated at a constant elongation rate of 12 in. per minute until break. Each specimen for ASTM D5035 was raveled to give a testing width of 2 in. by removing an approximately equal number of yarns from each side, which oriented the yarns parallel to the force to be applied.

For percent hysteresis determination, 6 in.×6 in. samples of stretch denim were mounted on an INSTRON® testing machine with a 3.5 in. gauge length and cycled two times between 0% and 30% elongation at a constant elongation rate of 12 in. per minute. The percent hysteresis of a given cyclic test was determined as the area between the loading and unloading curves. The percent hysteresis was then calculated as:

$$\% Hysteresis = 100 * \frac{\begin{matrix}Area under loading curve - \\ Area under unloading curve\end{matrix}}{Area under loading curve}$$

Percent hysteresis for a stretch denim sample is said to be good typically when percent hysteresis is lower, for example, when comparing percent hysteresis between two samples, A and B, A is said to have a good percent hysteresis when the percent hysteresis value for sample A is lower than the percent hysteresis value for sample B. For the present invention, the percent hysteresis tests are indicative of the level of structure retention, the degree of dimensional stability and the durability the can be achieved when applying the acrylic stretch coating onto a denim.

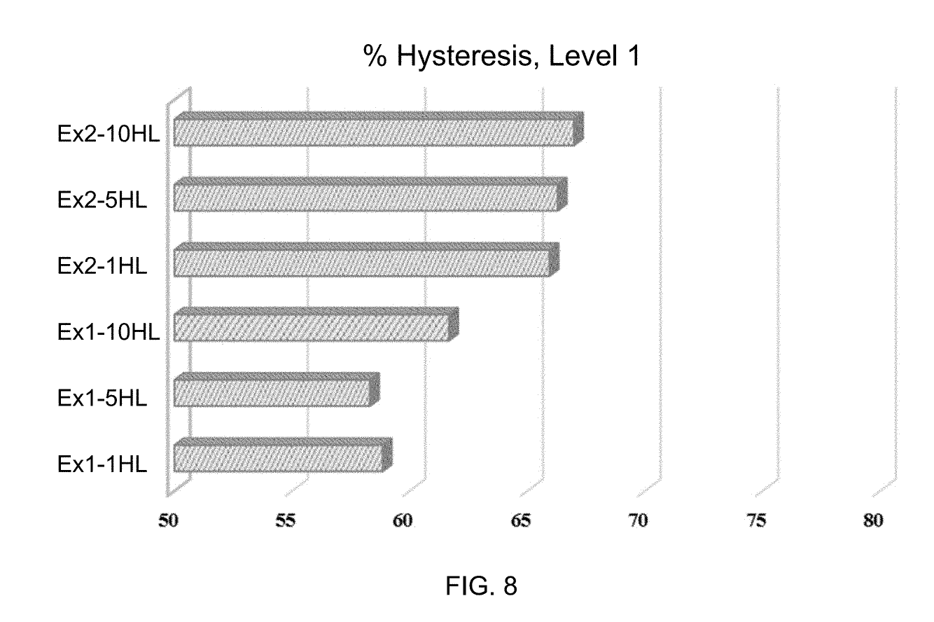

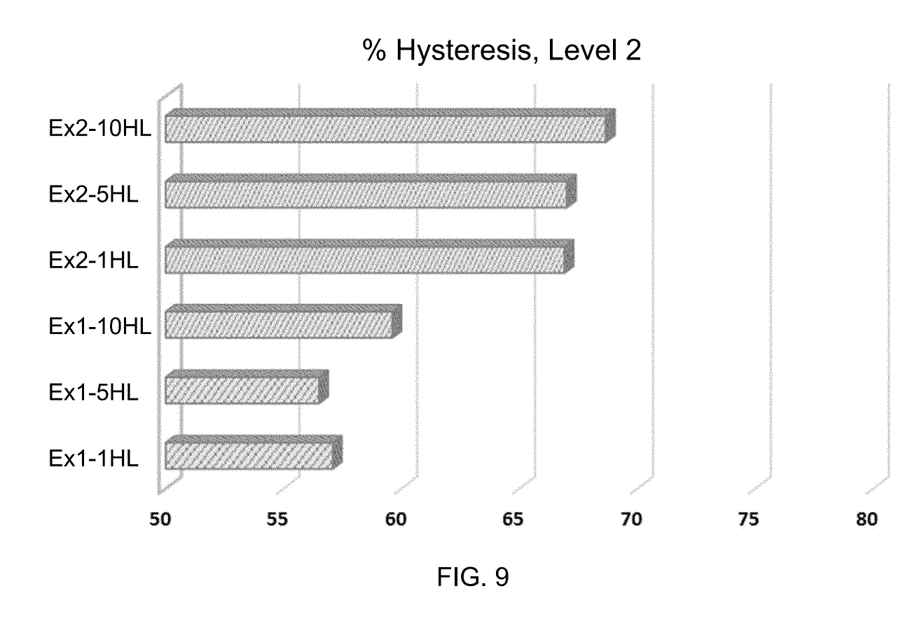

The inventive (Example 1, Ex1) and comparative (Example 2, Ex2) coated samples were home laundered (HL) for 1, 5 and 10 times and the % hysteresis was determined for each. Results are provided in Table 1, and are shown graphically in FIGS. 8 and 9. Percent hysteresis for an uncoated stretch denim sample is also provided for comparative purposes:

TABLE 1

| | % Hysteresis, | % Hysteresis, | % Hysteresis, |
|---|---|---|---|
| | Uncoated | Level 1 | Level 2 |
| Uncoated | 65.96 | — | — |
| Ex1, 1HL | — | 58.85 | 57.08 |
| Ex1, 5HL | — | 58.31 | 56.50 |
| Ex1, 10HL | — | 61.67 | 59.61 |
| Ex2, 1HL | — | 65.94 | 66.91 |
| Ex2, 5HL | — | 66.29 | 67.01 |
| Ex2, 10HL | — | 66.98 | 68.66 |

From Table 1 and FIGS. 8 and 9, it is apparent that the inventive acrylic liquid stretch coating improves the structure retention properties of stretch denims. The uncoated stretch denim had a % hysteresis of about 66%, and the coated acrylic samples all had improved percent hysteresis properties. Moreover, the structure retention properties were retained through multiple home launderings, indicating that the acrylic coating was durable. In contrast, the comparative (polyurethane) coatings exhibited no improvement in structure retention to the stretch denim fabrics.

### Example 3

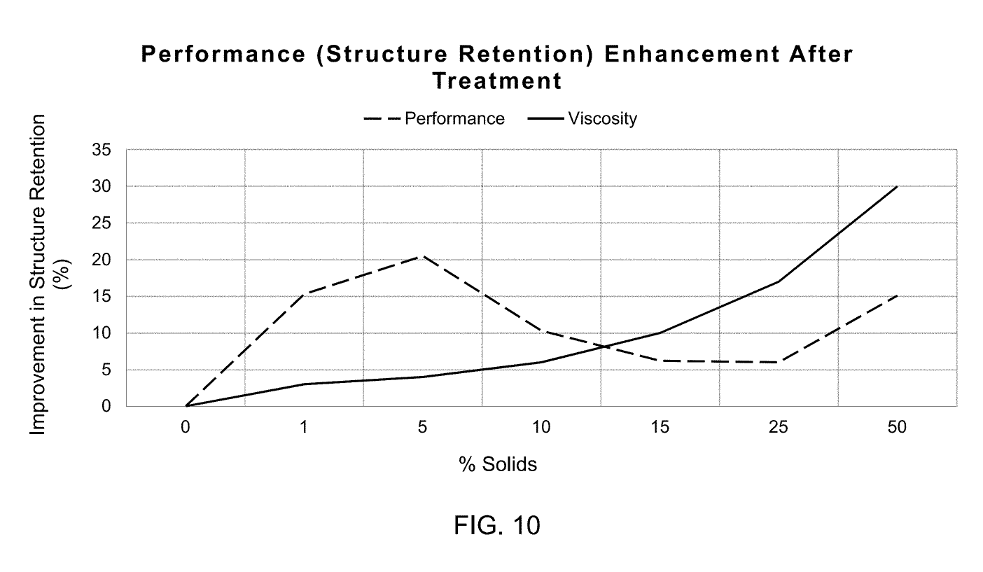

Performance of a diluted coating on the garment was also evaluated. Samples of the aqueous acrylic dispersion of Ex1 were diluted from 0-50% as shown below in Table 2. The aqueous acrylic dispersion was applied onto stretch denim fabrics and onto the high wear zones of the jeans, including areas in the hips, thighs, and knees, to create zones of variable stretch and variable compression. The coating was applied at ambient lab conditions, and the stretch denim products were placed in an oven at 110° C. for 10-15 minutes. Structure retention of the garments was determined according to the methods described herein. Results are shown in Table 2 and the graph in FIG. 10:

TABLE 2

| | | | % Improvement in Structure |
|---|---|---|---|
| | Dilution | Solid Content | Retention Compared to |
| Example | (%) | (%) | Untreated Garment |
| Ex3.1 | 5 | 1 | 15.3 |
| Ex3.2 | 10 | 5 | 20.5 |
| Ex3.3 | 20 | 10 | 10.3 |
| Ex3.4 | 30 | 15 | 6.2 |
| Ex3.5 | 50 | 25 | 6.1 |
| C3 | N/A | 50 | 15.1 |

As Ex3.1-Ex3.5 show, a diluted coating still results in garments having enhanced performance as compared to an untreated (uncoated) garment.

### Example 4

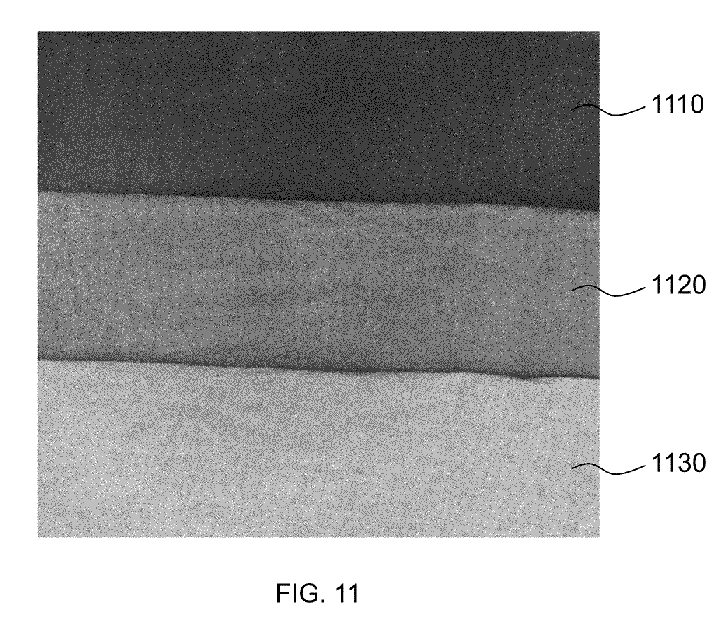

Fabrics having a coating including an additive including a dye were also prepared. A side-by-side comparison of the dyed fabrics is shown in the photograph in FIG. 11. Fabric 1110 included 1% blue dye, fabric 1120 included 1 wt % grey dye, and fabric 1130 was undyed.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A garment comprising yarns comprising an elastic component, the garment comprising a coating comprising an acrylic polymer or copolymer thereof, the coating located on at least one discrete region of the garment.

2. The garment according to claim 2, wherein the coating further comprises a crosslinker component, and wherein the coating comprises from about 1 wt % to about 99 wt % of the acrylic polymer and from about 1 wt % to about 99 wt % of the crosslinker component.

3. The garment according to claim 1 or 2, wherein the coating further comprises from greater than 0 wt % to about 5 wt % of an additional additive.

4. The garment according to claim 3, wherein the additional additive comprises a dye, a pigment, an ultraviolet resistant additive, an antimicrobial additive, an odor control additive, a moisture transport additive, a flame retardant, an insect repellant, a fragrance, or a combination thereof.

5. The garment according to any of claims 1 to 4, wherein the yarns further comprise natural fibers, synthetic fibers or a combination thereof.

6. The garment according to claim 5, wherein the natural fibers comprise cotton, wool, silk, hemp, flax, jute, Kapok and combinations thereof.

7. The garment according to claim 5, wherein the synthetic fibers comprise viscose, polyester, nylon, polypropylene, modacrylic, aramid, thermoplastic urethane (TPU), polybenzimidazole (PBI), polybenzoxazole (PBO), melamine and combinations thereof.

8. The garment according to any of claims 1 to 7, wherein the garment is pants and the at least one discrete region of the garment is a hip region, a thigh region, a knee region or a combination thereof.

9. The garment according to any of claims 1 to 7, wherein the garment is a shirt and the at least one discrete region is a collar region, a sleeve region, a cuff region or a combination thereof.

10. The garment according to any of claims 1 to 9, wherein the at least one discrete region of the garment has a structure retention that is at least 5% improved as compared to a discrete region of a garment comprising a substantially similar coating comprising a polyurethane polymer instead of the acrylic polymer or copolymer thereof.

11. The garment according to any of claims 1 to 10, wherein the coating is applied onto the at least one discrete region of the garment at a level of from 20 grams per square meter (g/m²) to 150 g/m² and the at least one discrete region has a structure retention of less than 60% hysteresis after 5 launderings.

12. A method for applying a coating to at least one discrete region of a garment with a spray apparatus, the spray apparatus comprising a conveyance system, at least one spray nozzle and a controller, the method comprising:
a. placing the garment on the conveyance system;
b. advancing the garment proximate to the at least one spray nozzle;
c. operating the controller to activate the at least one spray nozzle and apply the coating to the at least one discrete region of the garment.

13. The method according to claim 12, wherein the at least one spray nozzle applies the coating to the at least one discrete region of the garment with pulse width modulation.

14. The method according to claim 13, wherein the pulse width modulation comprises a cycle time of up to 15,000 cycles per minute.

15. The method according to any of claims 11 to 14, wherein the controller is a 24 volt direct current (24 VDC) controller.

16. The method according to any of claims 11 to 15, wherein the at least one spray nozzle applies the coating to the at least one discrete region in an even flat fan spray pattern.

17. The method according to any of claims 11 to 16, wherein the coating is applied at a viscosity of about 3 centipoise (cP) to about 50 cP.

18. The method according to any of claims 11 to 17, wherein:
the garment is pants and the at least one discrete region of the garment onto which the coating is applied is a hip region, a thigh region, a knee region or a combination thereof or
the garment is a shirt and the at least one discrete region of the garment onto which the coating is applied is a collar region, a sleeve region, a cuff region or a combination thereof.

19. The method according to any of claims 11 to 18, wherein the coating comprises an acrylic polymer or copolymer thereof.

20. The method according to claim 19, wherein the coating further comprises a crosslinker component, and wherein the coating comprises from about 1 wt % to about 99 wt % of the acrylic polymer and from about 1 wt % to about 99 wt % of the crosslinker component.
